(19) United States
(12) Patent Application Publication
(10) Pub. No.: US 2019/0394427 A1
(43) Pub. Date: Dec. 26, 2019

(54) SYSTEM FOR PERCEIVING AND CO-PROCESSING INTELLIGENT CONNECTED VEHICLE-ORIENTED SCENE IMAGE DATA

(71) Applicant: Chang'an University, Xi'an (CN)

(72) Inventors: Xiangmo ZHAO, Xi'an (CN); Zhanwen LIU, Xi'an (CN); Shan LIN, Xi'an, (CN); Xing FAN, Xi'an (CN); Chao SHEN, Xi'an (CN); Ming DONG, Xi'an (CN); Jiang XU, Xi'an (CN); Tao GAO, Xi'an (CN); Runmin WANG, Xi'an (CN); Xinyu LIAN, Xi'an (CN); Fan ZHANG, Xi'an (CN)

(21) Appl. No.: 16/400,057

(22) Filed: May 1, 2019

(30) Foreign Application Priority Data
Jun. 20, 2018 (CN) 201810636310.0

(51) Int. Cl. H04N 7/18; H04W 4/44; G06K 9/00

(52) U.S. Cl. CPC H04N 7/181; H04W 4/44; H04W 84/042; G06K 9/00798; G06K 9/00785

(57) ABSTRACT

A system for perceiving and co-processing intelligent connected vehicle-oriented scene image data, including a device for perceiving and processing single-mobile intelligent agent image data, a roadside infrastructure apparatus and a remote server. An in-vehicle image processing platform in the device enables single-view image data processing by performing algorithms such as target detection and recognition, and scene stream estimation. A roadside image processing platform in the roadside infrastructure apparatus enables depression angle image data processing and multi-view image fusion processing by performing algorithms such as target detection and recognition, and image fusion. The system is simple in structure, stable in constitution, high in image data processing efficiency, high and stable in communication data transmission speed, thereby realizing priori mapping of an urban complicated intersection, coordinated traffic control and guidance of intelligent connected vehicles and the like, and accelerating the implementation of the intelligent connected vehicle industry.

### CROSS-REFERENCE TO RELATED APPLICATIONS

This application claims the benefit of priority from Chinese Patent Application No. CN201810636310.0, filed on Jun. 20, 2018. The content of the aforementioned application, including any intervening amendments thereto, is incorporated herein by reference in its entirety.

### TECHNICAL FIELD

The present invention relates to a system for perceiving and co-processing image data, in particular to a system for perceiving and co-processing intelligent connected vehicle-oriented scene image data.

### BACKGROUND OF THE INVENTION

Intelligent connected vehicles will become a big highlight in the future strategy of the automobile industry in China along with technical breakthroughs in many fields such as 5G communications, big data and artificial intelligence, which are important for China to transform and upgrade the automobile industry to make larger industries strong, and play the great strategic role in terms of molding the industrial ecology, promoting the national innovation, improving the traffic safety, and achieving the energy conservation and emission reduction. As a combination of the unmanned technique and the network communication technique, the intelligent connected vehicle integrates the knowledge of a wide variety of sciences. Among them, it is significant to understand urban traffic scenes, which is the key of realizing the unmanned technique. At present, most of intelligent connected vehicle-oriented scenes are understood and perceived based on an expensive laser radar. Understanding the scenes by employing a visual sensor is still in the research stage, and a system for perceiving and co-processing intelligent connected vehicle-oriented scene image data has not yet been developed. In view of this, it is urgent to develop a system for perceiving and co-processing intelligent connected vehicle-oriented scene understanding image data, which is effective and easy to implement and provides a decision basis for autonomous control of the intelligent vehicles.

### SUMMARY OF THE INVENTION

In order to overcome the defects in the prior art, an object of the present invention is to provide a system for perceiving and co-processing intelligent connected vehicle-oriented scene image data.

In order to achieve the above object, the present invention adopts the following technical solution.

A system for perceiving and co-processing intelligent connected vehicle-oriented scene image data includes a device for perceiving and processing single-mobile intelligent agent image data, a roadside infrastructure apparatus and a remote server.

The device for perceiving and processing single-mobile intelligent agent image data includes a road scene image acquisition sensor, an in-vehicle image processing platform and an in-vehicle wireless transmission platform, wherein a road scene image acquisition camera is configured to acquire road scene image information and transmit it to the in-vehicle image processing platform; the in-vehicle image processing platform is configured to receive the road scene image information and complete view transition, target detection, target recognition, and scene stream estimation data processing; and the in-vehicle wireless transmission platform is configured to transmit data after being processed by the in-vehicle image processing platform.

The roadside infrastructure apparatus includes a 360-degree panoramic camera, a roadside image processing platform and a roadside wireless transmission platform, wherein the 360-degree panoramic camera is configured to acquire roadside road scene information and transmit it to the roadside image processing platform, the roadside image processing platform is configured to realize depression angle target detection as well as multi-view target detection and recognition result fusion; and the roadside wireless transmission platform is configured to perform vehicle-road communications with the in-vehicle wireless transmission platform, and upload image data of the roadside image processing platform to the remote server.

The remote server is configured to receive the image data acquired by the roadside infrastructure apparatus, complete swarm intelligence co-processing, and transmit a processing result to all vehicles within an effective range of an intersection.

Further, the road scene image acquisition camera is connected with the in-vehicle image processing platform through an RJ45 interface.

Further, the in-vehicle image processing platform employs an NVIDIA PX Xavier computer, which includes an 8-core CPU, a 512-core GPU, a CVA, an 8K HDR VP, an I/O interface, and an input/output data interface supporting Ethernet, CAN, and Flexray in-vehicle communications.

Further, the in-vehicle wireless transmission platform employs an OBU module of an LTE-V DTVL3000, supports two cellular and straight-through working modes, and supports a CAN/serial port/RJ45/USB interface.

Further, the in-vehicle image processing platform and the in-vehicle wireless transmission platform are powered by conversion of an in-vehicle power circuit module.

Further, the 360-degree panoramic camera is capable of monitoring a coverage area of about 400 square meters without blind spots, has a 360-degree panoramic view, and may acquire road scene information from a depression angle.

Further, the roadside image processing platform includes a video decoding module, a data storage module, a target detection and recognition module, an image fusion module and a data searching and matching module, wherein the video decoding module is connected with the 360-degree panoramic camera through a 360-degree panoramic camera video cable and connected with the data storage module through a connection cable; the image fusion module is simultaneously connected with the data storage module, the target detection and recognition module and the data searching and matching module; the data storage module and the target detection and identification module are connected to each other; and the data storage module and the data searching and matching module simultaneously exchange information with the in-vehicle image processing platform through wireless communication transmission.

Further, the roadside wireless transmission platform employs a RSU module of an LTE-V DTVL3000.

Further, the remote server includes a host, a display and an input/output device.

Further, the device for perceiving and processing single-mobile intelligent agent image data realizes wireless transmission communications with the roadside infrastructure apparatus through an LTE-V Cell, and the roadside infrastructure apparatus realizes communications with the remote server through an LTE-V.

Compared with the prior art, the present invention has the following beneficial technical effects.

The system for perceiving and co-processing intelligent connected vehicle-oriented scene image data provided by the present invention includes the device for perceiving and processing single-mobile intelligent agent image data, the roadside infrastructure apparatus and the remote server. The device for perceiving and processing single-mobile intelligent agent image data includes the road scene image acquisition sensor, the in-vehicle image processing platform and the in-vehicle wireless transmission platform. The road scene image acquisition camera is configured to acquire road scene image information and transmit it to the in-vehicle image processing platform. The in-vehicle image processing platform is configured to receive the road scene image information and complete view transition, target detection, target recognition, and scene stream estimation data processing. The in-vehicle wireless transmission platform is configured to transmit data after being processed by the in-vehicle image processing platform. The system for perceiving and co-processing image data is realized by the device for perceiving and processing single-mobile intelligent agent image data, the roadside infrastructure apparatus and the remote server. The in-vehicle image processing platform in the device for perceiving and processing single-mobile intelligent agent image data realizes single-view image data processing by completing algorithms such as target detection and recognition, and scene stream estimation. The roadside image processing platform in the roadside infrastructure apparatus realizes depression angle image data processing and multi-view image fusion processing by completing the algorithms such as the target detection and recognition, and image fusion. Based on the high-efficiency algorithms and hardware, the system is stable in composition, high in image data processing speed and stable in transmission. The present invention is simple in structure, stable in composition, high in image data processing efficiency, and high and stable in communication data transmission speed, thereby realizing priori mapping of an urban complicated intersection, coordinated traffic control and guidance of intelligent connected vehicles and the like, and accelerating the implementation of the intelligent connected vehicle industry.

Further, all the modules are simultaneously connected with a data communication module, and the image processing platform is connected with the 360-degree panoramic camera through the RJ45 interface. The roadside wireless transmission platform acquires data transmitted by a single intelligent agent mainly by employing a RSU component in the LTE-V DTVL3000. The RSU component is mainly used in an outdoor roadside environment, which is of a three-proofings design so as to achieve the IP65 protection capability, and has the advantages of integrated design, small size, convenience in installation and use, and wide coverage due to adoption of a high-gain antenna. Further, the component supports plug and play, wirelessly transmits data back to a backend server, and facilitates data acquisition and subsequent operation and maintenance.

### BRIEF DESCRIPTION OF THE DRAWINGS

FIG. 1 is a schematic diagram of an application scene of the present invention.

FIG. 2 is a schematic diagram showing a structure of the present invention.

FIG. 3 is a schematic diagram showing a structure of a device for perceiving and processing single-mobile intelligent agent image data.

FIG. 4 is a schematic diagram of a roadside infrastructure structure.

### DETAILED DESCRIPTION OF EMBODIMENTS

The present invention will be further described in detail below with reference to accompanying drawings.

A system for perceiving and co-processing intelligent connected vehicle-oriented scene image data includes a device for perceiving and processing single-mobile intelligent agent image data, a roadside infrastructure apparatus and a remote server.

The device for perceiving and processing single-mobile intelligent agent image data includes a road scene image acquisition sensor, an in-vehicle image processing platform and an in-vehicle wireless transmission platform, wherein a road scene image acquisition camera is configured to acquire road scene image information and transmit it to the in-vehicle image processing platform; the in-vehicle image processing platform is configured to receive the road scene image information and complete view transition, target detection, target recognition, and scene stream estimation data processing; and the in-vehicle wireless transmission platform is configured to transmit data after being processed by the in-vehicle image processing platform.

The roadside infrastructure apparatus includes a 360-degree panoramic camera, a roadside image processing platform and a roadside wireless transmission platform, wherein the 360-degree panoramic camera is configured to acquire roadside road scene information and transmit it to the roadside image processing platform, the roadside image processing platform is configured to realize depression angle target detection as well as multi-view target detection and recognition result fusion; and the roadside wireless transmission platform is configured to perform vehicle-road communications with the in-vehicle wireless transmission platform, and upload image data of the roadside image processing platform to the remote server.

The remote server is configured to receive the image data acquired by the roadside infrastructure apparatus, complete swarm intelligence co-processing, and transmit a processing result to all vehicles within an effective range of an intersection.

1. The road scene image acquisition camera is connected with the in-vehicle image processing platform through an RJ45 interface.

The in-vehicle image processing platform employs an NVIDIA PX Xavier computer, which includes an 8-core CPU, a 512-core GPU, a CVA, an 8K HDR VP, an I/O interface, and an input/output data interface supporting Ethernet, CAN, and Flexray in-vehicle communications.

The in-vehicle wireless transmission platform employs an OBU module of an LTE-V DTVL3000, supports two cellular and straight-through working modes, and supports a CAN/serial port/RJ45/USB interface and the like.

The in-vehicle image processing platform and the in-vehicle wireless transmission platform are powered by conversion of an in-vehicle power circuit module.

2. The 360-degree panoramic camera is capable of monitoring a coverage area of about 400 square meters without blind spots, has a 360-degree panoramic view, and may acquire road scene information from a depression angle.

The roadside image processing platform mainly includes a video decoding module, a data storage module, a target detection and recognition module, an image fusion module and a data searching and matching module. The video decoding module is connected with the 360-degree panoramic camera through a 360-degree panoramic camera video cable and connected with the data storage module through a connection cable. The image fusion module is simultaneously connected with the data storage module, the target detection and recognition module and the data searching and matching module. The data storage module and the target detection and identification module are connected to each other. The data storage module and the data searching and matching module simultaneously exchange information with the in-vehicle image processing platform through wireless communication transmission.

The roadside wireless transmission platform employs a RSU module of an LTE-V DTVL3000.

The remote server includes a host, a display and an input/output device.

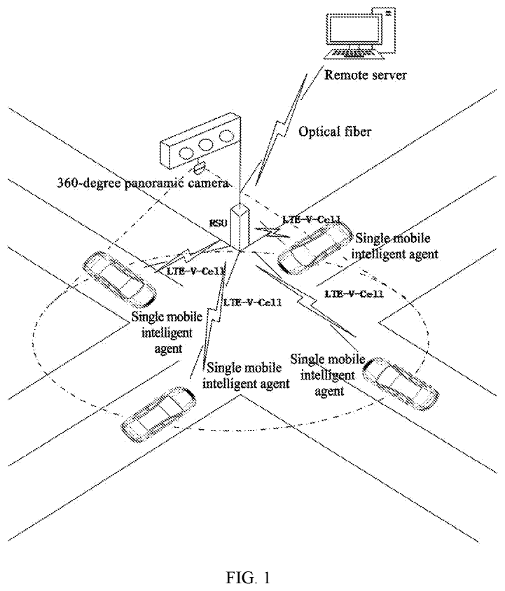

As shown in FIG. 1, a system for perceiving and co-processing intelligent connected vehicle-oriented scene image data is applied in a traffic scene, mainly in an intersection scene. A device for perceiving and processing single-mobile intelligent agent image data acquires and processes the traffic scene and transmits it to a roadside infrastructure wirelessly. The roadside infrastructure will receive data, a 360-degree panoramic camera acquires the data, and the received data and the acquired data will be wirelessly transmitted to a remote server for being co-processed.

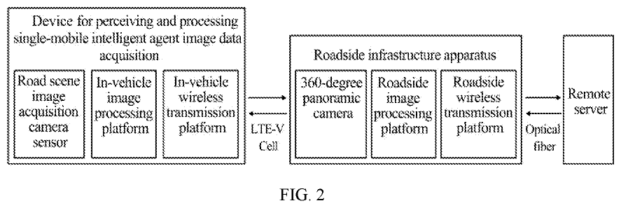

As shown in FIG. 2, a system for perceiving and co-processing intelligent connected vehicle-oriented scene image data provided by the present invention includes a device for perceiving and processing single-mobile intelligent agent image data, a roadside infrastructure apparatus and a remote server. The device for perceiving and processing single-mobile intelligent agent image data particularly includes a road scene image acquisition camera sensor, an in-vehicle image processing platform and an in-vehicle wireless transmission platform. The roadside infrastructure apparatus particularly includes a 360-degree panoramic camera, a roadside image processing platform and a roadside wireless transmission platform. The device for perceiving and processing single-mobile intelligent agent image data realizes wireless transmission communications with the roadside infrastructure apparatus through an LTE-V Cell, and the roadside infrastructure apparatus realizes communications with the remote server through an LTE-V.

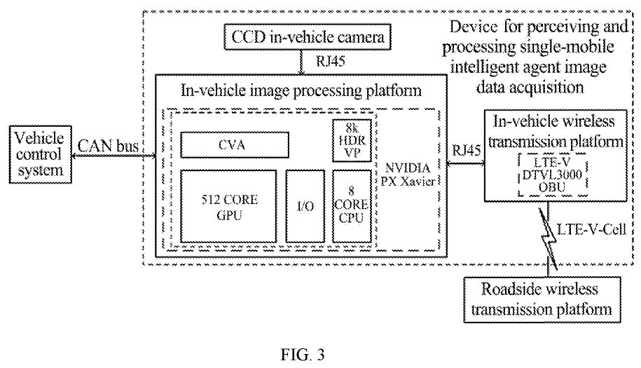

As shown in FIG. 3, an in-vehicle CCD camera serves as a road scene acquisition camera, which is installed between a front windshield and an inner rearview mirror of a vehicle, and is responsible for acquiring information of a road scene, including information about a road surface, a road layout, single intelligent agents at adjacent locations, a neighboring environment, a road obstacle and the like. An in-vehicle image processing platform employs a NVIDIA DRIVE PX2 artificial intelligence vehicle computing platform, including a mobile processor, a GPU processor, a multi-channel video and radar data interface, a power supply, a bus interface and the like, capable of fusing data from multiple cameras, laser radars, radars and ultrasonic sensors, perceiving an environment all around the vehicle and generating stable target images including static and dynamic target images. The in-vehicle image processing platform is connected with the road scene acquisition camera through an RJ45 interface and connected with a vehicle control system through a CAN bus to realize data information exchange between the two. An in-vehicle wireless transmission platform realizes data transmission between the single intelligent agents and a roadside infrastructure server by employing an OBU component in an LTE-V DTVL3000. The OBU component is based on a 3GPP LTE-V standard, supports two cellular and straight-through working modes, may be applied to a V2X scene required by the system, and supports a CAN/serial port/RJ45/USB interface and the like. The in-vehicle wireless transmission platform is connected with the in-vehicle image processing platform through the RJ45 interface, and realizes wireless transmission with a roadside wireless transmission platform through an LTE-V Cell.

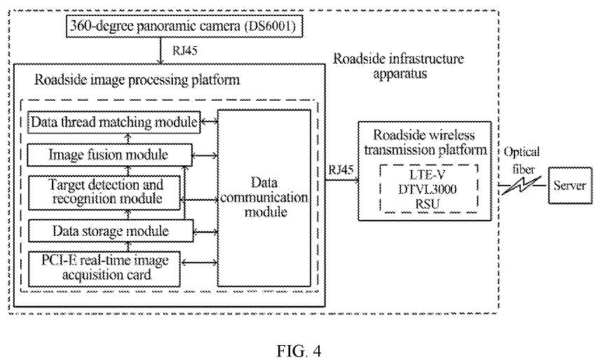

As shown in FIG. 4, a 360-degree panoramic camera is selected from a DS6001 series of cameras, its imaging lens is a fisheye type panoramic imaging optical system with an azimuth field viewing angle of 0 degree to 360 degrees and a pitch field viewing angle of 0 degree to −90 degrees. The 360-degree panoramic camera employs an ICR automatic switching mode for day/night switching, is capable of monitoring a coverage area of about 400 square meters without blind spots, has a 360-degree panoramic view, and acquires road scene information from a depression angle. A roadside image processing platform mainly includes a PCI-E real-time image acquisition card module, a data storage module, a target detection and recognition module, an image fusion module and a data searching and matching module. The PCI-E real-time image acquisition card module is connected with the 360-degree panoramic camera and connected with the data storage module through a connection cable. The image fusion module is simultaneously connected with the data storage module, the target detection and recognition module and the data searching and matching module. The data storage module and the target detection and identification module are connected to each other. All the modules are simultaneously connected with a data communication module, and an image processing platform is connected with the 360-degree panoramic camera through a RJ45 interface. A roadside wireless transmission platform acquires data transmitted by a single intelligent agent mainly by employing a RSU component in an LTE-V DTVL3000. The RSU component is mainly used in an outdoor roadside environment, which is of a three-proofings design so as to achieve the IP65 protection capability, and has advantages of integrated design, small size, convenience in installation and use, and wide coverage due to adoption of a high-gain antenna. The component supports plug and play, wirelessly transmits data back to a backend server, and facilitates data acquisition and subsequent operation and maintenance. The component is connected with a roadside image processing platform through the RJ45 interface, and realizes data transmission with a remote server through an optical fiber.

The present invention is stable in constitution, high in data processing efficiency, and high in image processing speed and capability, and may perceive and understand a three-dimensional scene of an urban complicated intersection by a multi-view swarm intelligent optimization algorithm in view of an urban road scene. Further, the present invention provides an intelligent connected vehicle-oriented traffic scene understanding method, which is effective and easy to implement, and provides a decision basis for autonomous control of the intelligent vehicles.

What is claimed is:

1. A system for perceiving and co-processing intelligent connected vehicle-oriented scene image data, comprising:
a device for perceiving and processing single-mobile intelligent agent image data,
a roadside infrastructure apparatus, and
a remote server;
wherein the device for perceiving and processing single-mobile intelligent agent image data comprises a road scene image acquisition sensor, an in-vehicle image processing platform and an in-vehicle wireless transmission platform, wherein a road scene image acquisition camera is configured to acquire road scene image information and transmit it to the in-vehicle image processing platform; the in-vehicle image processing platform is configured to receive the road scene image information and complete view transition, target detection, target recognition and scene stream estimation data processing; and the in-vehicle wireless transmission platform is configured to transmit data after being processed by the in-vehicle image processing platform;
the roadside infrastructure apparatus comprises a 360-degree panoramic camera, a roadside image processing platform and a roadside wireless transmission platform, wherein the 360-degree panoramic camera is configured to acquire roadside road scene information and transmit it to the roadside image processing platform, the roadside image processing platform is configured to realize depression angle target detection as well as multi-view target detection and recognition result fusion; and the roadside wireless transmission platform is configured to perform vehicle-road communications with the in-vehicle wireless transmission platform, and upload image data of the roadside image processing platform to the remote server; and
the remote server is configured to receive the image data acquired by the roadside infrastructure apparatus, complete swarm intelligence co-processing, and transmit a processing result to all vehicles within an effective range of an intersection.

2. The system of claim 1, wherein the road scene image acquisition camera is connected with the in-vehicle image processing platform through an RJ45 interface.

3. The system of claim 1, wherein the in-vehicle image processing platform employs an NVIDIA PX Xavier computer, which comprises an 8-core CPU, a 512-core GPU, a CVA, an 8K HDR VP, an I/O interface, and an input/output data interface supporting Ethernet, CAN, and Flexray in-vehicle communications.

4. The system of claim 1, wherein the in-vehicle wireless transmission platform employs an OBU module of an LTE-V DTVL3000, supports two cellular and straight-through working modes, and supports a CAN/serial port/RJ45/USB interface.

5. The system of claim 1, wherein the in-vehicle image processing platform and the in-vehicle wireless transmission platform are powered by conversion of an in-vehicle power circuit module.

6. The system of claim 1, wherein the 360-degree panoramic camera is capable of monitoring a coverage area of about 400 square meters without blind spots, has a 360-degree panoramic view, and may acquire road scene information from a depression angle.

7. The system of claim 1, wherein the roadside image processing platform comprises a video decoding module, a data storage module, a target detection and recognition module, an image fusion module and a data searching and matching module, wherein the video decoding module is connected with the 360-degree panoramic camera through a 360-degree panoramic camera video cable and connected with the data storage module through a connection cable; the image fusion module is simultaneously connected with the data storage module, the target detection and recognition module and the data searching and matching module; the data storage module and the target detection and identification module are connected to each other; and the data storage module and the data searching and matching module simultaneously exchange information with the in-vehicle image processing platform through wireless communication transmission.

8. The system of claim 1, wherein the roadside wireless transmission platform employs a RSU module of an LTE-V DTVL3000.

9. The system of claim 1, wherein the remote server comprises a host, a display and an input/output device.

10. The system of claim 1, wherein the device for perceiving and processing single-mobile intelligent agent image data realizes wireless transmission communications with the roadside infrastructure apparatus through an LTE-V Cell, and the roadside infrastructure apparatus realizes communications with the remote server through an LTE-V.
